(19) United States
(12) Patent Application Publication
(10) Pub. No.: US 2011/0037966 A1
(43) Pub. Date: Feb. 17, 2011

(54) System for Measuring a Physical Quantity and for the Map Representation of Said Measures

(75) Inventors: Bernard Levaufre, Cholet (FR); Jean-Michel Barbut, Lyon (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/739,634

(22) PCT Filed: Oct. 22, 2008
(86) PCT No.: PCT/EP2008/064295

§ 371 Date: Sep. 10, 2010

(30) Foreign Application Priority Data
Oct. 23, 2007 (FR) 07 07419

(51) Int. Cl. G01C 3/08

(52) U.S. Cl. 356/4.01

(57) ABSTRACT

The present invention relates to a system for measuring a physical magnitude and for the mapping representation of these measurements. The system for measuring a physical magnitude at different points of a zone to be examined, each measurement being located spatially, the system comprising a probe for measuring said physical magnitude, the system comprising a tachymeter associated with a target, said target being attached to the probe, the tachymeter determining the location of the target during each measurement in order to ascertain the position of the probe at the time of the measurement. The invention applies notably to the mapping of electromagnetic fields.

The present invention relates to a system for measuring a physical magnitude and for the mapping representation of these measurements. The invention applies notably to the mapping of electromagnetic fields.

With the upsurge in installations of devices that transmit electromagnetic waves, the problems concerning the safety of people and the reliability of the electronic equipment are becoming increasingly significant. Specifically, certain zones are subjected to powerful electromagnetic radiation that can cause malfunctions of nearby electronic equipment, even exceeding the limits accepted by the public health standards in force. Therefore, in order to identify the problematic zones in a given sector, the intensity of the electromagnetic radiation is mapped with the aid of measurements taken at different points of said sector.

In order to establish this type of mapping, a measurement probe is moved, the location of the probe being carefully recorded with each measurement. Each n-uplet of coordinates, corresponding respectively to each of the locations successively taken by the probe, is associated with each of the measurement values supplied by the probe. Obtaining pairs (coordinates, probe measurements) is found to be a laborious and protracted operation, the position of the probe having to be read off with each measurement. The problem also applies for the taking of measurements and the mapping relating to other physical magnitudes such as, for example, the temperature, the light intensity or the humidity.

In order to make it easier to obtain the coordinates of the probe, a satellite location system, such as a GPS (for “Global Positioning System”) terminal can be used. However, this solution has several drawbacks. On the one hand, the location obtained is relatively rough, notably for the coordinate indicating the height of the probe. On the other hand, this solution cannot be applied in a confined environment, notably in a basement or inside buildings, the receiver of the terminal being, in this case, incapable of capturing the satellite signals.

An object of the invention is to propose a system making it possible to take precise and spatially located measurements of a physical magnitude, notably in a confined environment. Accordingly, the subject of the invention is a system for measuring a physical magnitude at different points of a zone to be examined, each measurement being spatially located, the system comprising a probe for measuring said physical magnitude, the system being characterized in that it comprises a tachymeter associated with a target, said target being attached to the probe, the tachymeter determining the location of the target, and hence of the probe, during each measurement, in order to obtain concomitantly the value of the measurement and the position of the measurement, the probe being a probe for measuring the intensity of electromagnetic radiation, the material or materials forming the target being substantially neutral in electromagnetic terms, the magnetic permeability of said materials being close to that of a vacuum and the relative dielectric permittivity being, for example, of the order of 4 to 8 for electromagnetic waves of which the frequency varies between 1 MHz and 1 GHz.

The use of materials that are insulating from the electromagnetic point of view, that is to say not metallic, and not transmitters of electromagnetic radiation, makes it possible to not interfere with the measurement of nearfield electromagnetic field.

According to one embodiment, the tachymeter comprises a robotized head associated with means for automatic following of a target, said means following the target when it moves.

According to one embodiment, a computer is connected to the probe and to the tachymeter, the computer coupling, for each measurement taken, the value of the measurement with the position of the probe determined at the time of measurement. A control unit may be connected to the computer, the control unit transmitting a control signal to the computer in order to initiate a measurement.

According to one embodiment, when the probe is moved by an operator, the probe is attached to a support in order to isolate the operator from the probe.

Advantageously, the computer is provided with a software program for the mapping representation of the measurements taken.

Other features will become apparent on reading the following detailed description given as a nonlimiting example with respect to the appended drawings which represent:

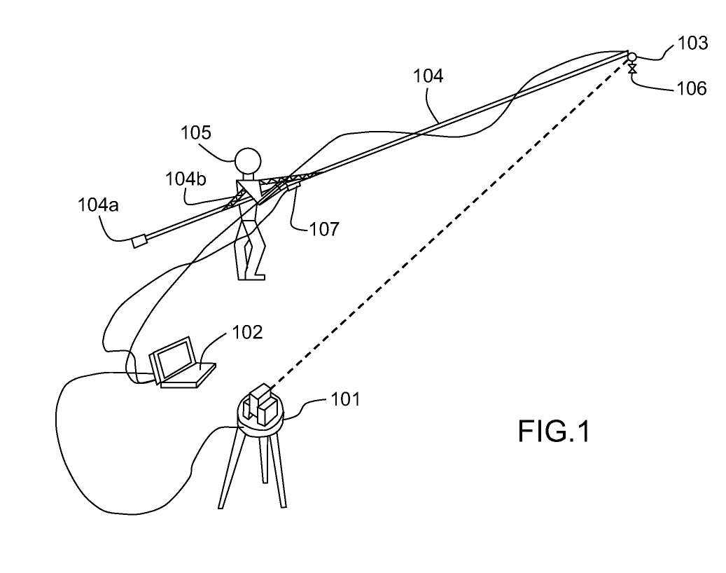

the single FIG. 1, an exemplary embodiment of the measurement system according to the invention.

FIG. 1 shows an exemplary embodiment of a measurement system according to the invention.

The system 100 comprises a tachymeter 101, a computer 102, a measurement probe 103 attached to an insulating pole 104 manipulated by an operator 105. A target 106 is attached to the measurement probe 103 and a control unit 107 that can be accessed by the operator 105 is placed on the insulating pole 104.

The description of the system 100 of FIG. 1 relates to the measurement of electromagnetic radiation; therefore the probe 103 makes it possible to measure the intensity of said radiation. Nevertheless, the system according to the invention may apply to measurements of all types of physical magnitudes, the measurement probe to be used then naturally being chosen according to the type of physical magnitude to be studied.

By virtue of these detection means, the tachymeter 101 makes it possible to ascertain precisely the location of the target 106 relative to its own position. The tachymeter 101 is preferably provided with a movable head comprising means for automatically following a target. In this manner, if the target 106 is moved by the operator 105, the tachymeter 101 is capable of following this target 106 during its movement. These automatic following means may notably comprise an infrared camera connected to a processor dedicated to shape recognition. According to a simpler application of the system 100, the tachymeter 101 comprises a head the position of which is adjusted manually in order to aim at the target 106, which is, for example, a catoptric reflecting prism.

The target 106 is attached to the probe 103 so that the position of the probe 103 is deduced from the measurement of the target 106 taken by the tachymeter 101. Preferably, the target 106 is neutral in electromagnetic terms, because it consists of a material that does not interfere with the electromagnetic fields measured.

The probe 103 is connected, for example via an optical link, to the computer 102. Moreover, the computer 102 is connected to the tachymeter 101, for example via an RS 232 serial link so that the tachymeter 101 can transmit the measured coordinates of the target 106 to the computer 102. Advantageously, the computer 102 is a device with a small space requirement such as a laptop computer, which allows the operator 105 to move it around with him while taking the measurements.

In the example, the computer 102 is connected to the control unit 107, for example via a wire or optical serial link or else via a USB link. This control unit 107 is actuated by the operator 105 every time the latter wishes to take a measurement. A control signal is then transmitted to the computer 102 by the control unit 107. The computer 102 is fitted with a specific software module making it possible to process this control signal. This software module initiates the transmission of two virtually simultaneous signals. A first signal is transmitted by the computer 102 to the probe 103 in order to initiate a measurement, and a second signal is transmitted to the tachymeter 101 for the purpose of determining the location of the target 106, and therefore of the probe 103. The measurement value originating from the probe 103 and the coordinates of the target 106 determined by the tachymeter 101 are then transmitted to the computer 102. Therefore, for one command from the operator 105 initiated via the control unit 107, the computer 102 receives a pair of values (measurement, coordinates of the measurement point). These pairs of values can be simply recorded on a memory medium and/or displayed in text form by a screen associated with the computer 102. According to a more advanced embodiment of the system, a software module executed by the computer 102 makes it possible to view a 2D and/or a 3D map of the measurement zones on the screen. The measurement points can be represented by a symbolic code, and the intensity of the measurement values can be associated with a color code. The operator 105 then has a synoptic representation of the measurements taken and is capable of making up for his possible omissions in the coverage of the sector to be studied.

According to certain embodiments of the system 100, the method of attachment chosen for joining the target 106 to the probe 103 requires a space of distance D between the target 106 and the probe 103. This space is materialized, in the example, by the presence of a vertical rigid arm the top end of which is placed beside the probe 103 and the bottom end of which is placed beside the target 106. In this case, each measurement value of the location of the target 106 must be corrected to take account of this space between the target 106 and the probe 103, namely in this example, adding the distance D to the measured height of the target 106 in order to ascertain the real height of the probe 103. For example, the computer 102 can be configured to systematically apply this correction to the positional measurement values transmitted by the tachymeter 101.

In the example, the measurement probe 103 is attached to the insulating pole 104 in order to impose a minimal distance between the probe 103 and the operator 105. Specifically, on the one hand, the presence of the operator 105 close to the probe 103 can adversely affect the measurements. On the other hand, zones are potentially exposed to considerable radiation, which may constitute a danger for an operator 105 moving around inside these zones. Other means of moving the probe 103 and/or of putting a distance between the probe 103 and the operator 105 can be envisaged; for example, the probe 103 can be placed on a vehicle or directed with the aid of a crane. In the example, the insulating pole 104 is provided with a balance weight 104a and is held with the aid of a harness 104b in order to relieve the operator 105. According to a simplified application of the system according to the invention, the probe 103 is held directly by the operator 105.

Measurements can be taken so long as the target 106 joined to the probe 103 remains in the field of vision of the tachymeter 101. A judicious placement of the tachymeter 101 is therefore recommended for the purpose of maximizing the spatial extent covered by the detection means of the tachymeter. When the sector to be studied cannot be covered by a single position of the tachymeter 101, several series of measurements are necessary, each series being carried out from a different location of the tachymeter 101. Preferably, in order to obtain a single map for the whole sector to be studied, in other words to produce measurements in one and the same spatial frame of reference, a reference position of the tachymeter 101 is chosen, said position being common to all the series of measurements. Therefore, at the time of a new placement of the tachymeter 101 associated with a transition from one series of measurements to the next, the location and orientation space between the new position of the tachymeter 101 and the reference position is entered, for example, into the computer 102. This space is taken into account by the computer 102 in order to reposition the measurements in one and the same spatial frame of reference.

The system according to the invention can, for example, be used on a worksite in order to identify the zones that are of danger to the personnel and in order to make it easier to make the site conform to the safety standards. It can also be used to determine the zones that are capable of receiving equipment that is sensitive to considerable electromagnetic fields, or else make it possible to draw up radiation diagrams of antennas.

One advantage of the system according to the invention is its simplicity and the speed with which it can be applied. It requires only one operator. Moreover, the location-measurement accuracy obtained is usually very satisfactory with respect to the required applications, of the order of one centimeter for a tachymeter-target distance of 300 m. Finally, the system can operate in conditions that are a priori unfavorable, for example in complete darkness and in rain.

Moreover, the system according to the invention can be easily transported and can be deployed on an outdoor measurement site having any relief or in a confined environment of any dimensions.

1. A system for measuring a physical magnitude at different points of a zone to be examined, each measurement being spatially located, the system comprising a probe for measuring said physical magnitude, the system comprising a tachymeter associated with a target, said target being attached to the probe, the tachymeter determining the location of the target, and hence of the probe, during each measurement, in order to obtain concomitantly the value of the measurement and the position of the measurement, the probe being a probe for measuring the intensity of electromagnetic radiation, the material or materials forming the target being substantially neutral in electromagnetic terms, the magnetic permeability of said materials being close to that of a vacuum.

2. The system as claimed in claim 1, wherein the tachymeter comprises a robotized head associated with means for automatic following of a target, said means following the target when it moves.

3. The system as claimed in claim 1, wherein a computer connected to the probe and to the tachymeter, the computer coupling, for each measurement taken, the value of the measurement with the position of the probe determined at the time of measurement.

4. The system as claimed in claim 3, further comprising a control unit connected to the computer, the control unit transmitting a control signal to the computer in order to initiate a measurement.

5. The system as claimed in claim 1, the probe being moved by an operator, wherein the probe is attached to a support in order to isolate the operator from the probe.

6. The system as claimed in claim 3, wherein the computer is provided with a software program for the mapping representation of the measurements taken.
